(19) United States
(12) Patent Application Publication
(10) Pub. No.: US 2023/0097754 A1
(43) Pub. Date: Mar. 30, 2023

(54) POSITIVE ACTIVE MATERIAL FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventor: Sung Ho CHOO, Yongin-si (KR)

(21) Appl. No.: 17/821,768

(22) Filed: Aug. 23, 2022

(30) Foreign Application Priority Data
Aug. 24, 2021 (KR) 10-2021-0111597

(51) Int. Cl. H01M 4/525; H01M 4/36; H01M 4/131

(52) U.S. Cl. CPC H01M 4/525; H01M 4/364; H01M 4/366; H01M 4/131; H01M 2004/028

(57) ABSTRACT

A positive active material for a rechargeable lithium battery may include a first positive active material including a lithium cobalt-based oxide doped with aluminum and coated with zirconium; and a second positive active material including a lithium cobalt-based oxide doped with aluminum and coated with zirconium, wherein a particle diameter of the second positive active is smaller than a particle diameter of the first positive active material, in the first positive active material, a doping amount of aluminum based on a total weight of the lithium cobalt-based oxide is about 0.50 wt % to about 0.80 wt %, in the second positive active material, a doping amount of aluminum based on the total weight of the lithium cobalt-based oxide is about 0.20 wt % to about 0.40 wt %, and a coating amount of zirconium based on a total weight of the positive active material is about 0.10 wt % to about 0.15 wt %.

### CROSS-REFERENCE TO RELATED APPLICATION

This application claims priority to and the benefit of Korean Patent Application No. 10-2021-0111597 filed in the Korean Intellectual Property Office on Aug. 24, 2021, the entire content of which is incorporated herein by reference.

### BACKGROUND

### 1. Field

One or more aspects of embodiments of the present disclosure are directed towards a positive active material for a rechargeable lithium battery and a rechargeable lithium battery including the same.

### 2. Description of the Related Art

In modern society, the convenience of portable electronic devices is changing the way of life. As the portable electronic devices gradually begin to be included in many parts of our life, rechargeable lithium batteries of higher or improved specifications used as a driving power source also are increasingly required (or are desired).

A positive active material used in the rechargeable lithium batteries for the portable electronic devices may be lithium cobalt oxide, and research to realize high capacity is in progress. The lithium cobalt oxide has high theoretical capacity of about 274 mAh/g, of which only about a half is actually used due to a capacity deterioration problem caused by a phase transition thereof. Particularly, as charging and discharging at a high voltage is necessary to achieve high energy density, and because the lithium cobalt oxide has an irreversible phase transition at the high voltage and a side reaction with an electrolyte solution, further research on improving structural stability of the lithium cobalt oxide is desirable.

In order to prepare a cobalt-based active material with excellent or suitable stability at a high voltage, a doping material may be used. Herein, in order to suppress or reduce structural collapse of the active material with a layered structure, a heterogeneous element in a set or predetermined amount may be doped thereon. The doped material serves to suppress or reduce the structural collapse by shrinkage and expansion according to the charging and discharging and realignment of the layered structure.

Information on various doping materials and doping contents thereof, which point to the best direction of suppressing or reducing a phase transition at a high voltage and a high temperature, while maintaining other properties, is available.

### SUMMARY

One or more aspects of embodiments of the present disclosure are directed toward a positive active material for a rechargeable lithium battery exhibiting high or suitable stability at high voltage and high temperature, and a rechargeable lithium battery having improved cycle-life characteristics at high voltage and high temperature while implementing high capacity.

In one or more embodiments, a positive active material for a rechargeable lithium battery includes a first positive active material including a lithium cobalt-based oxide doped with aluminum and coated with zirconium; and a second positive active material including a lithium cobalt-based oxide doped with aluminum and coated with zirconium, wherein a particle diameter of the second positive active is smaller than a particle diameter of the first positive active material, in the first positive active material, a doping amount of aluminum based on a total weight of the lithium cobalt-based oxide is about 0.50 wt % to about 0.80 wt %, in the second positive active material, a doping amount of aluminum based on the total weight of the lithium cobalt-based oxide is about 0.20 wt % to about 0.40 wt %, and a coating amount of zirconium based on a total weight of the positive active material is about 0.10 wt % to about 0.15 wt %.

In one or more other embodiments, a positive electrode for a rechargeable lithium battery including the positive active material is provided.

In one or more other embodiments, a rechargeable lithium battery, including the positive electrode, a negative electrode, and an electrolyte, is provided.

The positive active material for a rechargeable lithium battery prepared according to the embodiments has high or suitable stability at high temperature and high voltage, and a rechargeable lithium battery including the same may exhibit excellent or improved high-temperature cycle-life characteristics while implementing high capacity and high energy density.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view illustrating a rechargeable lithium battery according to one or more embodiments.

FIG. 2 is a scanning electron microscopic image of the positive active material of Example 1.

FIG. 3 is an energy dispersive X-ray spectroscopic analysis image of the positive active material of Example 1.

FIG. 4 is a transmission electron microscopic image and energy dispersive X-ray spectroscopic analysis image of the positive active material of Example 1.

FIG. 5 is a transmission electron microscopic image and an energy dispersive X-ray spectroscopic analysis image of the positive active material of Example 1.

FIG. 6 is an electron probe microanalysis image of the positive active material of Example 1.

FIG. 7 is a graph showing the particle size distributions of the first positive active materials prepared in Comparative Example 1-3, Example 2, Example 6, Example 9, and Comparative Example 5-3.

FIG. 8 is a graph showing the evaluation of high-temperature cycle-life characteristics of the battery cells of Comparative Examples 1-1 to 1-5.

FIG. 9 is a graph showing the evaluation of high-temperature cycle-life characteristics of the battery cells of Comparative Example 2-1 and Examples 1 to 3.

FIG. 10 is a graph showing the evaluation of high-temperature cycle-life characteristics of the battery cells of Comparative Example 3-1 and Examples 5 to 7.

FIG. 11 is a graph showing the evaluation of high-temperature cycle-life characteristics of the battery cells of Comparative Example 4-1 Examples 8 to 10.

FIG. 12 is a graph of dQ/dV analysis for the battery cells of Comparative Examples 4-1 and 4-2 and Examples 8 to 10.

### DETAILED DESCRIPTION

Hereinafter, embodiments will be described in more detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In the present disclosure, when particles are spherical, “diameter” indicates an average particle diameter, and when the particles are non-spherical, the “diameter” indicates a major axis length. In addition, the average particle diameter may be measured by a method well known to those skilled in the art, for example, may be measured by a particle size analyzer, or may be measured by a transmission electron micrograph or a scanning electron micrograph. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. It is also possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution.

As used herein, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items.

Herein, “or” is not to be construed as an exclusive meaning, for example, “A or B” is construed to include A, B, A+B, and the like.

Further, the use of “may” when describing embodiments of the present disclosure refers to “one or more embodiments of the present disclosure”.

Spatially relative terms, such as “beneath,” “below,” “lower,” “above,” “upper,” “bottom,” “top” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The electronic device and/or any other relevant devices or components according to embodiments of the present invention described herein may be implemented utilizing any suitable hardware, firmware (e.g. an application-specific integrated circuit), software, or a combination of software, firmware, and hardware. For example, the various components of the apparatus may be formed on one integrated circuit (IC) chip or on separate IC chips. Further, the various components of the apparatus may be implemented on a flexible printed circuit film, a tape carrier package (TCP), a printed circuit board (PCB), or formed on one substrate. Further, the various components of the apparatus may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

### Positive Active Material

Recently, a lithium cobalt-based positive active material has been developed to satisfy excellent or desirable properties at a high temperature as well as a high voltage. One or more embodiments provides a positive active material, which is prepared by coating a set or specific amount of metal oxide such as Zr having an oxidation number of +4 and the like, and doping Al at a set or specific concentration, by mixing two different types (or kinds) of the active materials. This positive active material has structural stability and high capacity at a high temperature and thus improves high-temperature cycle-life characteristics and electrochemical characteristics (dQ/dV) of a rechargeable lithium battery 45° C. when applied thereto.

As used herein, the rechargeable lithium battery may refer to, for example, a rechargeable lithium ion battery and/or a non-aqueous electrolyte rechargeable lithium battery. The rechargeable lithium battery, as used herein, may also refer to, for example, but is not limited to, a lithium metal battery. Here, in the present disclosure, although not intended to limit the disclosure, the presently described rechargeable lithium battery will be described as mainly directed toward the rechargeable lithium ion battery.

In one or more embodiments, a positive active material for a rechargeable lithium battery includes a first positive active material including a lithium cobalt-based oxide doped with aluminum and coated with zirconium; and a second positive active material including a lithium cobalt-based oxide doped with aluminum and coated with zirconium wherein a particle diameter of the second positive active is smaller than a particle diameter of the first positive active material. In the first positive active material, a doping amount of aluminum to the lithium cobalt-based oxide is about 0.50 wt % to about 0.80 wt %, in the second positive active material, a doping amount of aluminum to the lithium cobalt-based oxide is about 0.20 wt % to about 0.40 wt %, and a coating amount of zirconium based on the total weight of the positive active material is about 0.10 wt % to about 0.15 wt %.

The positive active material for a rechargeable lithium battery has suitable structural stability and high capacity at a high temperature and a high voltage, and a rechargeable lithium battery including the same may exhibit high charge and discharge efficiency and high-temperature cycle-life characteristics, as well as realize high capacity and high energy density.

The lithium cobalt-based oxide is a compound including lithium, cobalt, aluminum, and oxygen elements, and may be an oxide further including a transition metal, a general metal, and/or a non-metal element in addition thereto, and may be expressed as lithium cobalt-based oxide doped with aluminum or as lithium cobalt aluminum-based oxide.

The lithium cobalt-based oxide may be particle-shaped, and the first positive active material may have a structure including a lithium cobalt-based oxide particle and a zirconium coating layer on the surface thereof. The zirconium coating layer may be positioned on the whole or a portion of the surface of the lithium cobalt-based oxide particle.

The zirconium coating refers to coating with a compound containing zirconium. Herein, the compound containing zirconium may be, for example, zirconium oxide, zirconium hydroxide, zirconium carbonate, and/or the like, and may be a compound further containing elements such as lithium, cobalt, and/or aluminum in addition to zirconium.

The lithium cobalt-based oxide of the first positive active material may be represented by Chemical Formula 1.

Liₐ₁Coₓ₁Al_{y1}M¹_{z1}O_{2-b1}. Chemical Formula 1

In Chemical Formula 1, 0.8≤a1≤1.2, 0.9560≤x1≤0.9819, 0.0180≤y1≤0.0290, 0≤z1≤0.015, x1+y1+z1=1, 0≤b1≤0.05, and M¹ is B, Ba, Ca, Ce, Cr, Cu, F, Fe, Mg, Mn, Mo, Nb, P, S, Si, Sr, V, W, Zr, or a combination thereof.

The lithium cobalt-based oxide of the second positive active material may be represented by Chemical Formula 2.

Liₐ₂Coₓ₂Al_{y2}M²_{z2}O_{2-b2}. Chemical Formula 2

In Chemical Formula 2, 0.8≤a2≤1.2, 0.9705≤x2≤0.9927, 0.0073≤y2≤0.0145, 0≤z2≤0.015, x2+y2+z2=1, 0≤b2≤0.05, and M² is B, Ba, Ca, Ce, Cr, Cu, F, Fe, Mg, Mn, Mo, Nb, P, S, Si, Sr, V, W, Zr, or a combination thereof.

The first positive active material and the second positive active material may be appropriately mixed to finely or suitably control an Al-doping amount on each lithium cobalt-based oxide and adjust a total Zr-coating amount, thereby increasing structural stability and improving high-temperature cycle-life characteristics and electrochemical characteristics (dQ/dV).

A ratio of an Al weight of the first positive active material to a Zr weight of the positive active material for the rechargeable lithium battery may be about 3.3 to about 8.0, for example, about 3.4 to about 8.0, about 3.5 to about 8.0, or about 3.6 to about 7.0. When the above ratio is satisfied, the positive active material for a rechargeable lithium battery may be structurally suitably stable and exhibit excellent or improved high-temperature characteristics and electrochemical characteristics.

A ratio of an Al oxidation number of the first positive active material to a Zr oxidation number of the positive active material for a rechargeable lithium battery may be about 2.4 to about 6.0, for example, about 2.5 to about 5.8, or about 2.6 to about 5.5. When the oxidation number ratio is satisfied, the positive active material for a rechargeable lithium battery is structurally suitably stable and may implement excellent or improved high-temperature characteristics and electrochemical characteristics.

An average particle diameter (D50) of the first positive active material may be about 13 μm to about 25 μm, for example, about 15 μm to about 25 μm, or about 18 μm to about 23 μm. When any of these ranges are satisfied, high capacity may not only be realized, but also mixture density of the positive electrode plate may be improved, realizing energy density and exhibiting excellent or improved high-temperature cycle-life characteristics. When the first positive active material has an average particle diameter of less than about 13 μm, the first positive active material may not exhibit desired energy density due to insufficient capacity or low mixture density, resulting in being unsuitable for a commercially available battery.

In one or more embodiments, an average particle diameter (D50) of the second positive active material may be about 2 μm to about 6 μm, for example, about 3 μm to about 5 μm. A positive active material for a rechargeable lithium battery including this second positive active material may realize high mixture density and achieve high capacity and high energy density.

In one or more embodiments, when the average particle diameter of the first positive active material is a, and the average particle diameter of the second positive active material is b, a and b may satisfy 3b≤a≤4b. When a and b satisfy this relationship, capacity characteristics and high-temperature characteristics may be improved while maximizing or improving a mixture density.

In the positive active material according to one or more embodiments, based on the total amount of the first positive active material and the second positive active material, the first positive active material may be included in an amount of about 60 wt % to about 90 wt %, for example, about 70 wt % to about 90 wt % and the second positive active material may be included in an amount of about 10 wt % to about 40 wt %, for example, about 10 wt % to about 30 wt %. When the content ratio of the first positive active material and the second positive active material is within any of the above ranges, the positive active material including the same may implement a high capacity, improve a mixture density, and exhibit a high energy density.

### Method for Preparing Positive Active Material

The method of preparing a positive active material for a rechargeable lithium battery according to one or more embodiments includes mixing a first cobalt oxide, a lithium raw material and an aluminum raw material, and heat-treating the resultant to obtain a first positive active material; mixing a second cobalt-based oxide, a lithium raw material, and an aluminum raw material and heat-treating the resultant to obtain a second positive active material; and coating the zirconium compound by mixing the first positive active material and the second positive active material.

In the preparing process of the first positive active material, an input amount of the aluminum raw material may be about 0.50 wt % to about 0.80 wt % based on the total weight of the first positive active material. In the preparing process of the second positive active material, an input amount of the aluminum raw material may be about 0.20 wt % to about 0.40 wt % based on the total weight of the second positive active material.

The heat-treating may be performed, for example, at a temperature of about 800° C. to about 1100° C., about 850° C. to about 1050° C., or about 890° C. to about 1010° C., for about 5 hours to about 25 hours, for example about 8 hours to about 15 hours.

A particle diameter (e.g., an average particle diameter) of the second positive active material is smaller than that of the first positive active material, and each of particle diameters may be adjusted by adjusting the heat-treating temperature and time in the preparing process of each of the first positive active material and the second positive active material.

The mixing of the first positive active material and the second positive active material in the preparing method may be performed, for example, by mixing about 60 wt % to about 90 wt % of the first positive active material and about 10 wt % to about 40 wt % of the second positive active material have.

The coating of the zirconium compound may be performed by mixing the first positive active material, the second positive active material, and the zirconium compound and heat-treating the mixture. The coating may be performed in a dry method, for example, after adding a zirconium compound to the mixture of the positive active material and then heat-treating the resultant at about 600° C. to about 980° C. or at about 650° C. to about 950° C. for about 5 hours to about 25 hours. The zirconium compound may be, for example, zirconium oxide. In this case, the zirconium compound may be added such that the amount of zirconium is about 0.10 wt % to about 0.15 wt % based on the total content of the positive active material.

### Positive Electrode

A positive electrode for a rechargeable lithium battery may include a current collector and a positive active material layer disposed on the current collector. The positive active material layer may include a positive active material, and may further include a binder and/or a conductive material.

The binder improves binding properties of positive active material particles with one another and with a current collector. Examples thereof may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The content of the binder in the positive active material layer may be about 1 wt % to about 5 wt % based on the total weight of the positive active material layer.

The conductive material is included to provide or improve electrode conductivity. Any suitable electrically conductive material may be used as a conductive material unless it causes a chemical change. Examples of the conductive material may include a carbon-based material such as natural graphite, artificial graphite, carbon black, acetylene black, ketjen black, a carbon fiber, a carbon nanofiber, carbon nanotube, and/or the like; a metal-based material of a metal powder and/or a metal fiber including copper, nickel, aluminum, silver, and/or the like; a conductive polymer such as a polyphenylene derivative; and mixtures thereof.

The content of the conductive material in the positive active material layer may be about 1 wt % to about 5 wt % based on the total weight of the positive active material layer.

An aluminum foil may be used as the current collector, but is not limited thereto.

The positive electrode may have a loading level of about 15 mg/cm² to about 25 mg/cm², for example, about 16 mg/cm² to about 22 mg/cm². This may refer to a loading level of the positive active material layer applied to one side of the current collector.

The positive electrode may have a mixture density of about 3.8 g/cc to about 4.2 g/cc, for example, about 3.9 g/cc to about 4.2 g/cc, or about 4.0 g/cc to about 4.2 g/cc. This may refer to a density of the positive electrode active material layer after pressing.

### Negative Electrode

The negative electrode for a rechargeable lithium battery may include, for example, a current collector and a negative active material layer on the current collector. The negative active material layer may include a negative active material, and may further include a binder, a conductive material.

The negative active material may include a material that reversibly intercalates/deintercalates lithium ions, a lithium metal, a lithium metal alloy, a material capable of doping/dedoping lithium, and/or transition metal oxide.

The material that reversibly intercalates/deintercalates lithium ions may include, for example, crystalline carbon, amorphous carbon, or a combination thereof as a carbon-based negative active material. The crystalline carbon may be non-shaped (e.g., without a set or specific shape), or sheet, flake, spherical, and/or fiber shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative active material and/or a Sn-based negative active material. The Si-based negative active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, or a combination thereof, but not Si), and the Sn-based negative active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, or a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and combinations thereof.

The silicon-carbon composite may be, for example, a silicon-carbon composite including a core including crystalline carbon and silicon particles, and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, and/or a polymer resin such as a phenol resin, a furan resin, and/or a polyimide resin. In this case, the content of silicon may be about 10 wt % to about 50 wt % based on the total weight of the silicon-carbon composite. In some embodiments, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. A thickness of the amorphous carbon coating layer may be about 5 nm to about 100 nm. An average particle diameter (D50) of the silicon particles may be about 10 nm to about 20 μm. The average particle diameter (D50) of the silicon particles may be about 10 nm to about 200 nm. The silicon particles may exist in an oxidized form, and in this case, an atomic content ratio of Si:O in the silicon particles indicating a degree of oxidation may be about 99:1 to about 33:67. The silicon particles may be SiOₓ particles, and in this case, the range of x in SiOₓ may be greater than about 0 and less than about 2. As used herein, when a definition is not otherwise provided, an average particle diameter (D50) indicates a particle where an accumulated volume is about 50 volume % in a particle distribution.

The Si-based negative active material and/or Sn-based negative active material may be mixed with the carbon-based negative active material. When the Si-based negative active material and/or the Sn-based negative active material and the carbon-based negative active material are mixed and used, the mixing ratio may be a weight ratio of about 1:99 to about 90:10.

In the negative active material layer, the negative active material may be included in an amount of about 95 wt % to about 99 wt % based on the total weight of the negative active material layer.

In one or more embodiments, the negative active material layer may further include a binder, and may optionally further include a conductive material. The content of the binder in the negative active material layer may be about 1 wt % to about 5 wt % based on the total weight of the negative active material layer. In addition, when the conductive material is further included, the negative active material layer may include about 90 wt % to about 98 wt % of the negative active material, about 1 wt % to about 5 wt % of the binder, and about 1 wt % to about 5 wt % of the conductive material.

The binder serves to better adhere the negative active material particles to each other and also to better adhere the negative active material to the current collector. The binder may be a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or one or more combinations thereof.

The water-soluble binder may include a rubber binder and/or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and combinations thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and combinations thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. As the alkali metal, Na, K and/or Li may be used. The amount of the thickener used may be about 0.1 parts by weight to about 3 parts by weight based on 100 parts by weight of the negative active material.

The conductive material is included to provide electrode conductivity. Any suitable electrically conductive material may be used as a conductive material unless it causes a chemical change. Examples of the conductive material include a carbon-based material such as natural graphite, artificial graphite, carbon black, acetylene black, ketjen black, a carbon fiber, a carbon nanofiber, carbon nanotube, and/or the like; a metal-based material of a metal powder and/or a metal fiber including copper, nickel, aluminum silver, and/or the like; a conductive polymer such as a polyphenylene derivative; or one or more mixtures thereof.

The current collector may include one or more selected from a copper foil, a nickel foil, a stainless steel foil, a titanium foil, a nickel foam, a copper foam, a polymer substrate coated with a conductive metal, and combinations thereof.

### Rechargeable Lithium Battery

One or more other embodiments provide a rechargeable lithium battery including a positive electrode, a negative electrode, a separator between the positive electrode and the positive electrode, and an electrolyte. Here, the aforementioned electrode may be a positive electrode and/or a negative electrode.

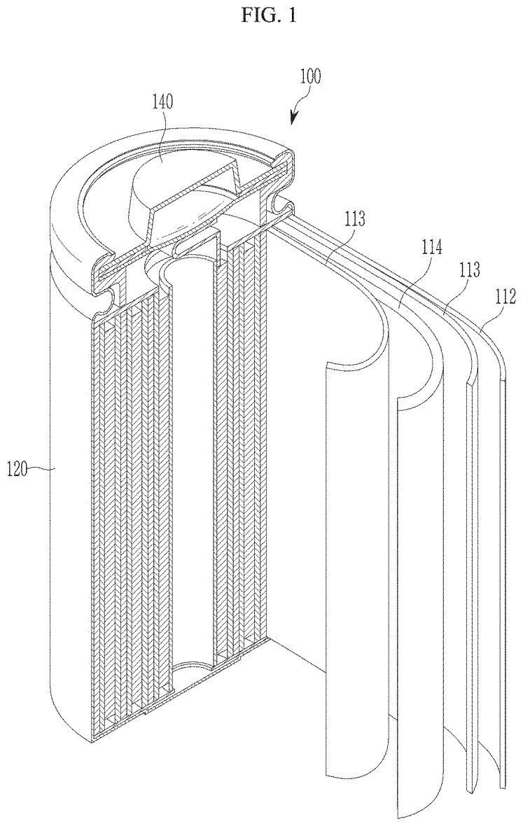

FIG. 1 is a schematic view illustrating a rechargeable lithium battery according to one or more embodiments. Referring to FIG. 1, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte for a rechargeable lithium battery impregnating the positive electrode 114, the negative electrode 112, and the separator 113, a battery case 120 housing the battery cell, and a sealing member 140 sealing the battery case 120.

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, and/or alcohol-based solvent, and/or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may be methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like, and the ketone-based solvent may be cyclohexanone, and/or the like. In one or more embodiments, the alcohol-based solvent may be ethyl alcohol, isopropyl alcohol, etc., and the aprotic solvent may be nitriles such as R—CN (where R is a C2 to C20 linear, branched, or cyclic hydrocarbon group and may include a double bond, an aromatic ring, and/or an ether bond), amides such as dimethylformamide, dioxolanes such as 1,3-dioxolane, sulfolanes, and/or the like.

The non-aqueous organic solvent may be used singularly or in a mixture.

When the organic solvent is used in a mixture, the mixture ratio may be controlled in accordance with a desirable battery performance.

In one or more embodiments, in the case of the carbonate-based solvent, a mixture of a cyclic carbonate and a chain carbonate may be used. In this case, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent, in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be used.

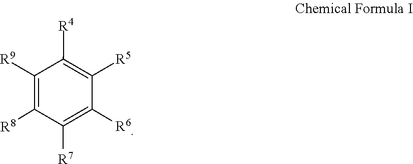

In Chemical Formula I, R⁴ to R⁹ may be the same or different and may be selected from hydrogen, a halogen, a C1 to C10 alkyl group, a C1 to C10 haloalkyl group, and a combination thereof.

Non-limiting examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

The electrolyte may further include vinylene carbonate and/or an ethylene carbonate-based compound of Chemical Formula II in order to improve cycle-life of a battery.

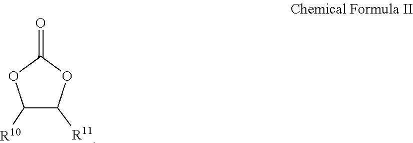

In Chemical Formula II, R¹⁰ and R¹¹ may be the same or different, and may be selected from hydrogen, a halogen, a cyano group, a nitro group, and a fluorinated C1 to C5 alkyl group, provided that at least one of R¹⁰ and R¹¹ is selected from a halogen, a cyano group, a nitro group, and a fluorinated C1 to C5 alkyl group, but both of R¹⁰ and R¹¹ are not hydrogen.

Examples of the ethylene-based carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive for improving cycle-life may be used within an appropriate or suitable range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt include at least one supporting salt selected from LiPF₆, LiBF₄, LiSbF₆, LiAsF₆, LiN(S₂C₂F₅)₂, Li(CF₃SO₂)₂N, LiN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), (wherein x and y are natural numbers, for example, an integer ranging from 1 to 20), lithium difluoro(bisoxolato) phosphate, LiCl, LiI, LiB(C₂O₄)₂ (lithium bis(oxalato) borate; LiBOB), and lithium difluoro(oxalato)borate (LiDFOB).

The lithium salt may be used in a concentration ranging from about 0.1 M to about 2.0 M. When the lithium salt is included at the above concentration range, an electrolyte may have excellent or improved performance and lithium ion mobility due to optimal or suitable electrolyte conductivity and viscosity.

The separator 113 separates a positive electrode 114 and a negative electrode 112 and provides a transporting passage for lithium ions and may be any suitable separator in a rechargeable lithium battery (e.g., a lithium ion battery). For example, it may have low resistance to ion transport and excellent or suitable impregnation for an electrolyte. For example, separator may be selected from a glass fiber, polyester, Teflon, polyethylene, polypropylene, polytetrafluoroethylene, and combinations thereof. It may have a form of a non-woven fabric or a woven fabric. For example, in a lithium ion battery, a polyolefin-based polymer separator such as polyethylene and/or polypropylene may be utilized. In order to ensure or improve the heat resistance and/or mechanical strength, a coated separator including a ceramic component and/or a polymer material may be used. Optionally, it may have a mono-layered or multi-layered structure.

Rechargeable lithium batteries may be classified as lithium ion batteries, lithium ion polymer batteries, and lithium polymer batteries, according to the presence of a separator and the type (or kind) of electrolyte used therein. The rechargeable lithium batteries may have a variety of suitable shapes and sizes, and include cylindrical, prismatic, coin, and/or pouch-type batteries (e.g., pouch batteries), and may be thin film batteries or may be relatively bulky in size. Suitable structures and manufacturing methods for rechargeable lithium batteries (e.g., lithium ion batteries) pertaining to this disclosure should be known in the art.

The rechargeable lithium battery according to one or more embodiments may implement high capacity, excellent or improved storage stability at high temperature, cycle-life characteristics, and high rate capability, and thus may be used in information technology (IT) mobile devices and/or the like.

Hereinafter, examples of the present invention and comparative examples are described. It is to be understood, however, that the examples are provided for the purpose of illustration and are not to be construed as limiting the present invention.

### EXAMPLE 1

### Preparation of Positive Active Material

First cobalt carbonate, which is a precursor of a first positive active material, was prepared through co-precipitation by using cobalt sulfate and then, was heat-treated through annealing, thus preparing first cobalt oxide. The first cobalt oxide, aluminum oxide, magnesium carbonate, and Li₂CO₃ were mixed in a mole ratio of 97.69:1.81:0.5:104 and then, heat-treated at about 1080° C. under 15 hours under an air atmosphere, thus preparing a first positive active material (Li_{1.04}Co_{0.9769}Al_{0.0181}Mg_{0.005}O₂) having an average particle diameter (D50) of about 20 μm.

Second cobalt carbonate, which is a precursor of a second positive active material, was prepared through co-precipitation by using cobalt sulfate and then, was heat-treated through annealing, thus preparing second cobalt oxide. The second cobalt oxide, aluminum oxide, magnesium carbonate, and Li₂CO₃ were mixed in a mole ratio of 98.23:1.27:0.5:102 and then, heat-treated at about 910° C. for 15 hours under an air atmosphere, preparing a second positive active material (Li_{1.02}Co_{0.9823}Al_{0.0127}Mg_{0.005}O₂) having an average particle diameter (D50) of about 4 μm.

The first positive active material and the second positive active material were mixed in a weight ratio of 8:2, and 0.1 mol % of zirconium oxide based on a total weight of the two active materials was added thereto and then, the resulting mixture was secondarily fired at 950° C. under an air atmosphere for 15 hours, thus preparing a positive active material.

### Manufacture of Positive Electrode

95 wt % of the positive active material, 3 wt % of a polyvinylidene fluoride binder, and 2 wt % of a carbon nanotube conductive material were mixed in an N-methylpyrrolidone solvent, thus preparing positive active material slurry. The positive active material slurry was coated on an aluminum current collector and then, dried and pressed to prepare a positive electrode. A loading level of the positive electrode plate was about 16.7 mg/cm², and mixture density thereof was about 4 g/cc.

### Manufacture of Rechargeable Lithium Battery Cell

The prepared positive electrode was used with a lithium metal counter electrode, a separator with a polyethylene polypropylene multi-layer structure was interposed therebetween, and an electrolyte solution prepared by adding 1.0 M LiPF₆ lithium salt to a mixed solvent of ethylene carbonate and diethyl carbonate in a volume ratio of 50:50 was injected thereinto, thus manufacturing a coin half-cell.

### EXAMPLES 2 TO 10 AND COMPARATIVE EXAMPLES

Each positive active material, positive electrode, and battery cell of Examples and Comparative Examples were manufactured in substantially the same manner as in Example 1, except that the Al doping amount of the first positive active material, the Al doping amount of the second positive active material, and the Zr coating amount was varied based on a total weight of the entire positive active material as shown in Table 1. In Table 1 below, unit ppm may be based on a weight and refers to wt %×10⁴.

TABLE 1

| | Al doping amount | Al doping amount | Zr coating amount |
|---|---|---|---|
| | of first positive | of second positive | of total positive |
| | active material | active material | active material |
| | (ppm) | (ppm) | (ppm) |
| Comparative | 3500 | 3500 | 700 |
| Example 1-1 | | | |
| Comparative | 3500 | 3500 | 1000 |
| Example 1-2 | | | |
| Comparative | 3500 | 3500 | 1200 |
| Example 1-3 | | | |
| Comparative | 3500 | 3500 | 1400 |
| Example 1-4 | | | |
| Comparative | 3500 | 3500 | 1600 |
| Example 1-5 | | | |
| Comparative | 5000 | 3500 | 700 |
| Example 2-1 | | | |
| Example 1 | 5000 | 3500 | 1000 |
| Example 2 | 5000 | 3500 | 1200 |
| Example 3 | 5000 | 3500 | 1400 |
| Comparative | 5000 | 3500 | 1600 |
| Example 2-2 | | | |
| Comparative | 6500 | 3500 | 700 |
| Example 3-1 | | | |
| Example 5 | 6500 | 3500 | 1000 |
| Example 6 | 6500 | 3500 | 1200 |
| Example 7 | 6500 | 3500 | 1400 |
| Comparative | 6500 | 3500 | 1600 |
| Example 3-2 | | | |
| Comparative | 8000 | 3500 | 700 |
| Example 4-1 | | | |
| Example 8 | 8000 | 3500 | 1000 |
| Example 9 | 8000 | 3500 | 1200 |
| Example 10 | 8000 | 3500 | 1400 |
| Comparative | 8000 | 3500 | 1600 |
| Example 4-2 | | | |
| Comparative | 9500 | 3500 | 700 |
| Example 5-1 | | | |
| Comparative | 9500 | 3500 | 1000 |
| Example 5-2 | | | |
| Comparative | 9500 | 3500 | 1200 |
| Example 5-3 | | | |
| Comparative | 9500 | 3500 | 1400 |
| Example 5-4 | | | |
| Comparative | 9500 | 3500 | 1600 |
| Example 5-5 | | | |

By way of comparison, Comparative Examples 1-1 to 1-5 corresponded to a case of using less than 0.50 wt % of the first positive active material, Comparative Examples 2-1, 3-1 and 4-1 corresponded to a case of using less than 0.10 wt % of the Zr coating amount, Comparative Examples 2-2, 3-2, and 4-2 corresponded to a case of using greater than 0.15 wt % of the Zr coating amount, and Comparative Examples 5-1 to 5-5 corresponded to a case of using greater than 0.8 wt % of the first positive active material.

### EVALUATION EXAMPLE 1: ICP ANALYSIS

Inductively Coupled Plasma (ICP) spectroscopic analysis was performed with respect to the positive active materials according to the Examples and the Comparative Examples. Al content of each of the first positive active materials before Zr coating, Al content of each of the second positive active materials before the Zr coating, and Zr content of each of the entire positive active materials after the Zr coating were measured, and the results are shown in Table 2. In Table 2 below, unit ppm may be based on weight and refers to wt %×10⁴.

TABLE 2

| | Al doping amount | Al doping amount | Zr coating amount |
|---|---|---|---|
| | of first positive | of second positive | of total positive |
| | active material | active material | active material |
| | (ppm) | (ppm) | (ppm) |
| Comparative | 3562 | 3521 | 697 |
| Example 1-1 | | | |
| Comparative | 3557 | 3521 | 1021 |
| Example 1-2 | | | |
| Comparative | 3549 | 3521 | 1198 |
| Example 1-3 | | | |
| Comparative | 3536 | 3521 | 1430 |
| Example 1-4 | | | |
| Comparative | 3550 | 3521 | 1665 |
| Example 1-5 | | | |
| Comparative | 5001 | 3521 | 710 |
| Example 2-1 | | | |
| Example 1 | 5025 | 3521 | 1030 |
| Example 2 | 4988 | 3521 | 1242 |
| Example 3 | 4975 | 3521 | 1448 |
| Comparative | 5010 | 3521 | 1624 |
| Example 2-2 | | | |
| Comparative | 6455 | 3521 | 698 |
| Example 3-1 | | | |
| Example 5 | 6497 | 3521 | 981 |
| Example 6 | 6502 | 3521 | 1212 |
| Example 7 | 6511 | 3521 | 1425 |
| Comparative | 6504 | 3521 | 1694 |
| Example 3-2 | | | |
| Comparative | 8087 | 3521 | 690 |
| Example 4-1 | | | |
| Example 8 | 7998 | 3521 | 1002 |
| Example 9 | 7940 | 3521 | 1233 |
| Example 10 | 8052 | 3521 | 1417 |
| Comparative | 8033 | 3521 | 1597 |
| Example 4-2 | | | |
| Comparative | 9511 | 3521 | 699 |
| Example 5-1 | | | |
| Comparative | 9444 | 3521 | 1023 |
| Example 5-2 | | | |
| Comparative | 9405 | 3521 | 1260 |
| Example 5-3 | | | |
| Comparative | 9534 | 3521 | 1405 |
| Example 5-4 | | | |
| Comparative | 9555 | 3521 | 1677 |
| Example 5-5 | | | |

Referring to Table 2, Zr was not doped but coated, and both the Examples and the Comparative Examples were Al-doped and Zr-coated according to the designated contents.

### EVALUATION EXAMPLE 2: SEM/EDAX ANALYSIS

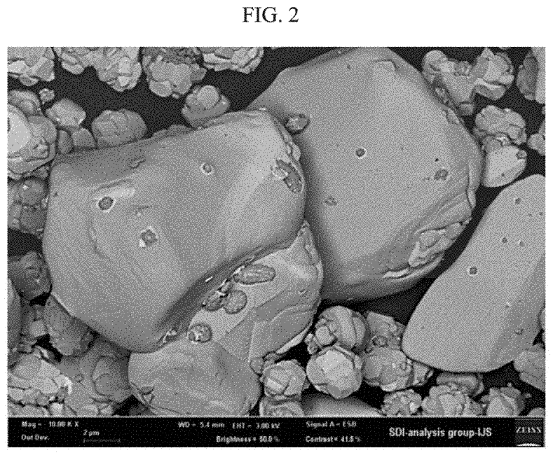

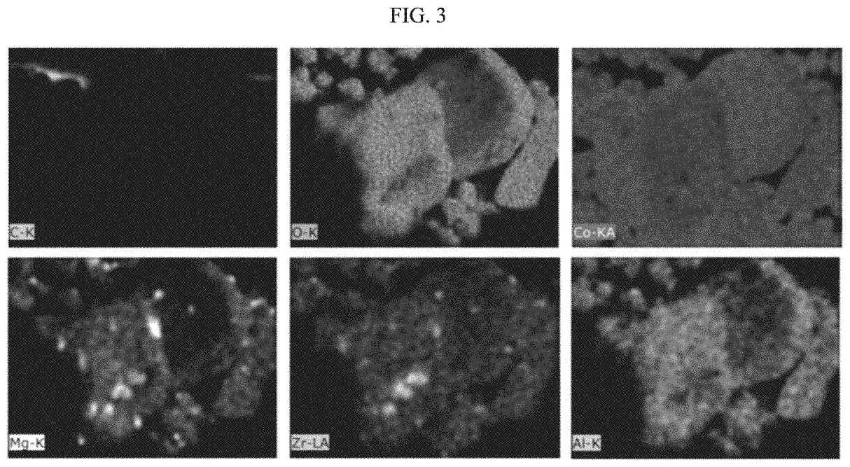

FIG. 2 is a scanning electron microscopic (SEM) image of the positive active material of Example 1. FIG. 3 is an image obtained by performing energy dispersive X-ray spectroscopy (EDAX) through the SEM image of FIG. 2. From FIG. 3, Al doping and Zr coating were confirmed.

### EVALUATION EXAMPLE 3: TEM/EDAX ANALYSIS

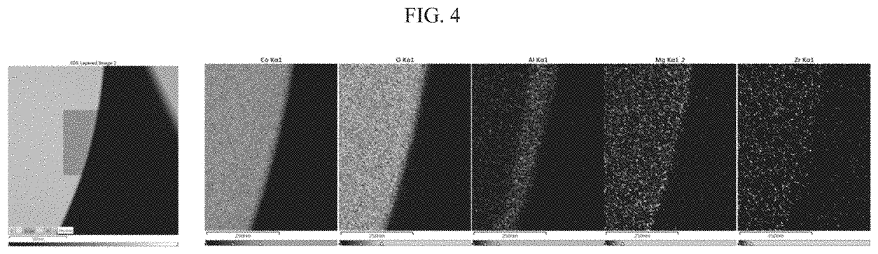

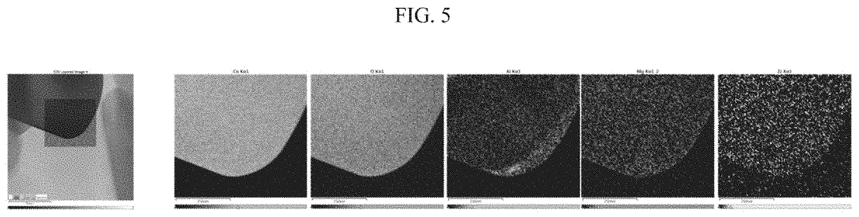

FIGS. 4 and 5 are an image taken with a transmission electron microscope (TEM) of the final positive active material prepared in Example 1, and an image of energy dispersive X-ray spectroscopy (EDAX) on the marked area, respectively.

Referring to FIGS. 4 and 5, Al doping and Zr coating were confirmed.

### EVALUATION EXAMPLE 4: EPMA ANALYSIS

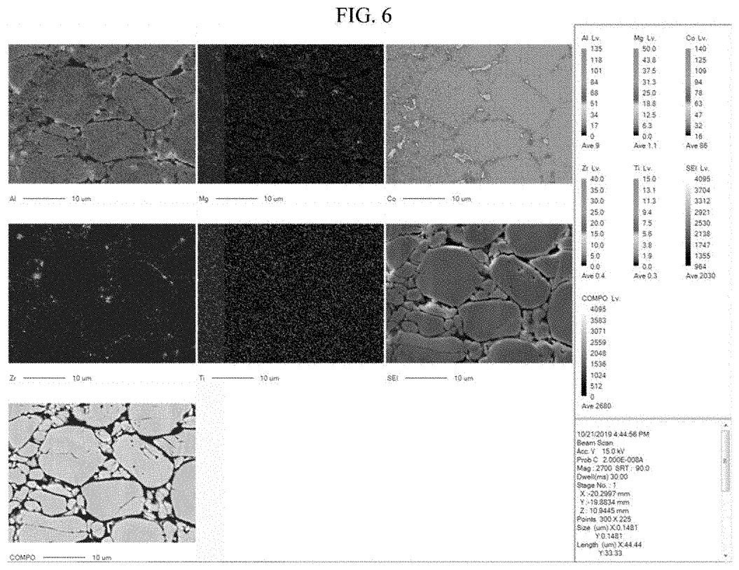

FIG. 6 is the electron probe microanalysis (EPMA) result for the final positive active material manufactured in Example 1. Referring to FIG. 6, Al doping and Zr coating were confirmed, and it was confirmed that Ti was not present.

### EVALUATION EXAMPLE 5: INITIAL CAPACITY AND EFFICIENCY ANALYSIS

The battery cells according to Examples 5, 6, and 7 and Comparative Examples 3-2 and 5-2 to 5-5 were charged to an upper limit voltage of 4.55 V at a constant current of 0.2 C and discharged to a cut-off voltage of 3.0 V at 0.2 C at 25° C. and then, measured with respect to initial discharge capacity, and then, a ratio of discharge capacity to charge capacity was calculated as efficiency, and the results are shown in Table 3. For better understanding, an Al doping amount of each first active material according to the Examples 5, 6, and 7 and Comparative Examples 3-2 and 5-2 to 5-5, a Zr coating amount of each entire active material, and charge and discharge efficiency data are summarized in Table 4.

TABLE 3

| | Charge capacity | Discharge capacity | |
|---|---|---|---|
| | (mAh/g) | (mAh/g) | Efficiency (%) |
| Example 5 | 209.6 | 195.4 | 93.2 |
| Example 6 | 209.3 | 194.6 | 93.0 |
| Example 7 | 209.0 | 194.0 | 92.8 |
| Comparative | 208.7 | 193.5 | 92.7 |
| Example 3-2 | | | |
| Comparative | 208.6 | 192.3 | 92.2 |
| Example 5-2 | | | |
| Comparative | 208.3 | 191.6 | 92.0 |
| Example 5-3 | | | |
| Comparative | 208.0 | 191.0 | 91.8 |
| Example 5-4 | | | |
| Comparative | 207.7 | 190.2 | 91.6 |
| Example 5-5 | | | |

TABLE 4

| | | Zr | | | | Zr | |
|---|---|---|---|---|---|---|---|
| | Al | coating | | | Al | coating | |
| | doping | amount | | | doping | amount | |
| | amount | of total | | | amount | of total | |
| | of first | positive | | | of first | positive | |
| | active | active | Charge and | | active | active | Charge and |
| | material | material | discharge | | material | material | discharge |
| | (ppm) | (ppm) | efficiency (%) | | (ppm) | (ppm) | efficiency (%) |
| Example | 6500 | 1000 | 93.2 | Comparative | 9500 | 1000 | 92.2 |
| 5 | | | | Example 5-2 | | | |
| Example | 6500 | 1200 | 93.0 | Comparative | 9500 | 1200 | 92.0 |
| 6 | | | | Example 5-3 | | | |
| Example | 6500 | 1400 | 92.8 | Comparative | 9500 | 1400 | 91.8 |
| 7 | | | | Example 5-4 | | | |
| Compar | 6500 | 1600 | 92.7 | Comparative | 9500 | 1600 | 91.6 |
| ative | | | | Example 5-5 | | | |
| Example | | | | | | | |
| 3-2 | | | | | | | |

Referring to Tables 3 and 4, Examples 5 to 7, in which the Al doping amount of each first positive active material was 0.65 wt %, and the Zr coating amount was in a range of 0.10 to 0.15 wt %, exhibited discharge capacity of greater than or equal to 193.5 mAh/g and charge and discharge efficiency of greater than or equal to 92.8%, and thus excellent or suitable initial discharge capacity and excellent or suitable charge and discharge efficiency was exhibited. In addition, Examples 5, 6, and 7 and Comparative Example 3-2, as the Zr coating amount increased (e.g., Examples 5, 6, and 7 and Comparative Example 3-2 contained increasing amounts of Zr coating), showed a continuous decrease in charge capacity and charge and discharge efficiency. Comparative Example 3-2, in which the Zr coating amount was greater than 0.15 wt %, exhibited deteriorated initial discharge capacity and decreased charge and discharge efficiency, compared with the examples in which the Zr coating amount was in a range of 0.01 to 0.15 wt %.

In addition, referring to Table 4, Comparative Examples 5-2 to 5-5, in which the Al amount was 0.95 wt % in each first positive active material, exhibited deteriorated initial discharge capacity, when respectively compared with Examples 5, 6, and 7 and Comparative Example 3-2 sequentially in the same row. It is believed or discovered, therefore, without being bound by any particular theory, that in the first positive active materials, when the aluminum doping amount was greater than 0.80 wt %, initial discharge capacity was deteriorated.

### EVALUATION EXAMPLE 6: PARTICLE DIAMETER AND PELLET DENSITY ANALYSIS

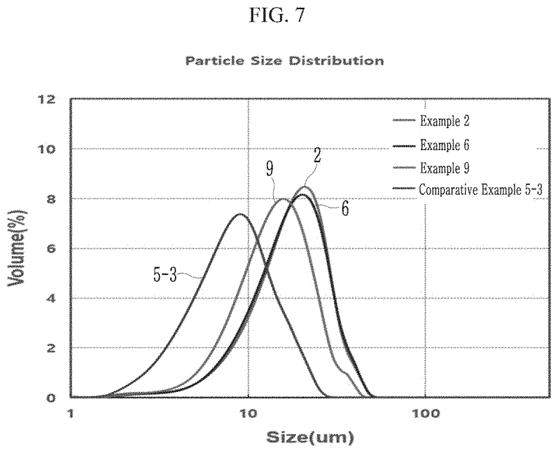

A particle diameter of each first positive active material of Comparative Examples 1-1 and 1-3, Examples 2, 6, and 9 and Comparative Example 5-3 and pellet density of each final active material of the first positive active materials and the second positive active materials were analyzed, and the results are shown in Table 5. FIG. 7 is a graph showing the particle size distributions of the first positive active material of Examples 2, 6, and 9 and Comparative Example 5-3.

TABLE 5

| | Al doping | Al doping | Zr coating | Particle | |
|---|---|---|---|---|---|
| | amount of first | amount of second | amount of total | diameter of first | Pellet density |
| | positive active | positive active | positive active | positive active | (g/cc) of |
| | material | material | material | material | total positive |
| | (ppm) | (ppm) | (ppm) | (D50, μm) | active material |
| Example 2 | 5000 | 3500 | 1200 | 18.82 | 3.98 |
| Example 6 | 6500 | 3500 | 1200 | 18.57 | 3.97 |
| Example 9 | 8000 | 3500 | 1200 | 14.93 | 3.91 |
| Comparative | 9500 | 3500 | 1200 | 8.71 | 3.78 |
| Example 5-3 | | | | | |

In Table 5, each first positive active material of Examples 2, 6, and 9 and Comparative Example 5-3 was prepared by using the same Zr coating amount of 1200 ppm but changing the Al doping amount alone. The first positive active material of Comparative Example 5-3, in which the Al doping amount of first positive active material was 0.95 wt %, had a particle diameter not growing to (e.g., not reaching) 10 μm, and the entire positive active material thereof exhibited reduced pellet density, which are confirmed in Table 4. In FIG. 7, the first positive active material of Comparative Example 5-3 exhibited a sharply reduced size. As such, a first positive active material having D50 of not less than 10 μm may not be suitable for application to commercially available rechargeable battery cells. In one or more embodiments, the Al doping amount was adjusted to be within a range of 0.50 wt % to 0.80 wt % to obtain a first positive active material with an appropriate or suitable size (about 13 to 25 μm), thus increasing pellet density of the entire positive active material and, simultaneously or concurrently, improving initial capacity, charge and discharge efficiency, cycle-life characteristics, and the like.

### EVALUATION EXAMPLE 7: HIGH-TEMPERATURE CYCLE-LIFE CHARACTERISTICS

The battery cells according to the Examples and the Comparative Examples were charged and discharged in the same manner as in Evaluation Example 5 and then, repetitively 30 times charged and discharged at 1 C at 45° C. to measure discharge capacity.

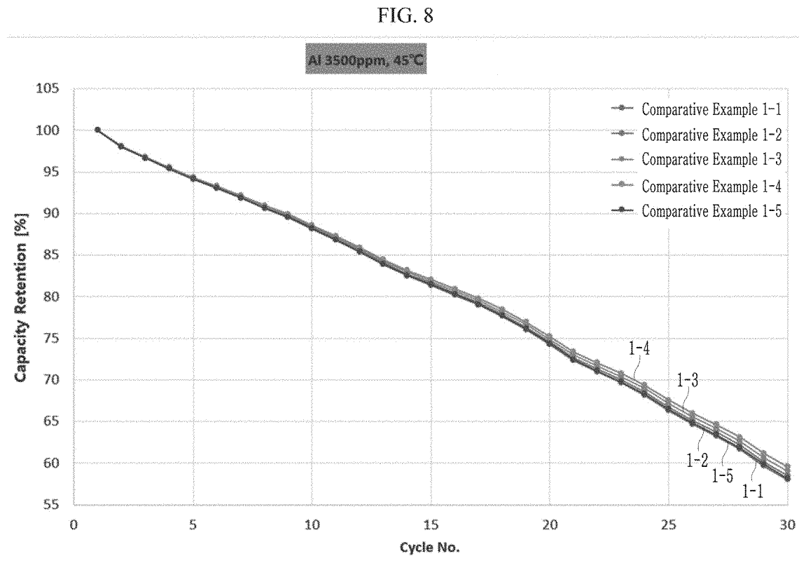

FIG. 8 is a graph illustrating high-temperature cycle-life characteristics evaluation of battery cells of Comparative Examples 1-1 to 1-5 in which the Al doping amount of the first positive active material is 0.35 wt %. In FIG. 8, Comparative Examples 1-1 to 1-5 all exhibited significantly reduced and insufficient or unsuitable high-temperature cycle-life characteristics. It is believed or discovered, therefore, without being bound by any particular theory, that when the Al doping amount of the first positive active material was less than 0.50 wt %, high-temperature cycle-life characteristics were deteriorated.

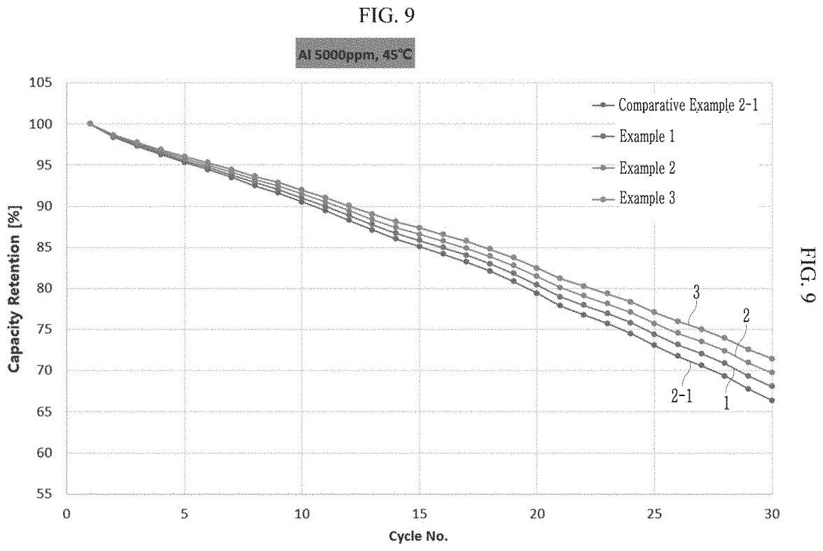

FIG. 9 is a graph showing the evaluation of high-temperature cycle-life characteristics of the battery cells of Comparative Examples 2-1 and Examples 1 to 3 in which the Al doping amount of the first positive active material is 0.50 wt % and the Zr doping amounts are different from each other. Referring to FIG. 9, Comparative Example 2-1, in which the Zr coating amount was 0.07 wt %, exhibited relatively reduced and insufficient or unsuitable high-temperature cycle-life characteristics, and Examples 1 to 3, in which the Zr coating amount was in a range of 0.10 to 0.15 wt %, exhibited improved high-temperature cycle-life characteristics.

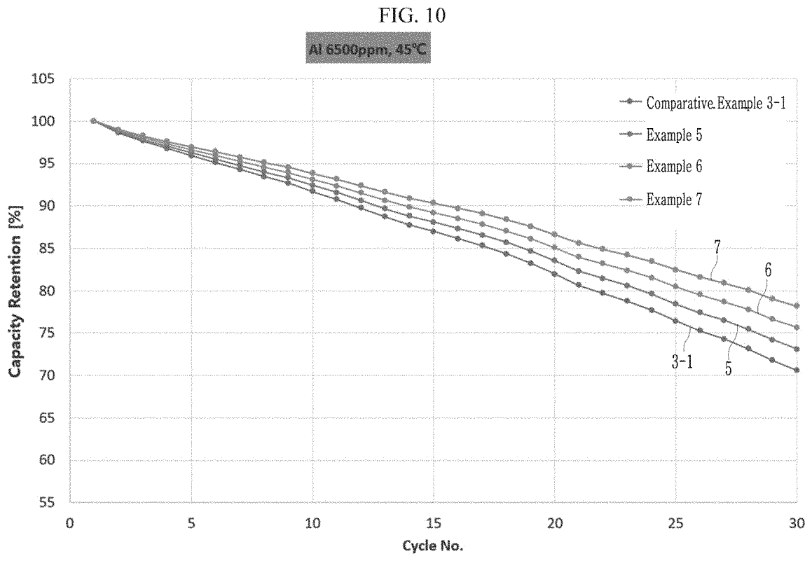

FIG. 10 is a graph showing the evaluation of high-temperature cycle-life characteristics for the battery cells of Comparative Examples 3-1 and Examples 5 to 7 in which the Al doping amount of the first positive active material is 0.65 wt % and the Zr coating amounts are different from each other. Referring to FIG. 10, Comparative Example 3-1, in which the Zr coating amount was 0.07 wt %, exhibited relatively reduced and insufficient or unsuitable high-temperature cycle-life characteristics, but Examples 5 to 7, in which the Zr coating amount was in a range of 0.10 to 0.15 wt %, exhibited improved high-temperature cycle-life characteristics.

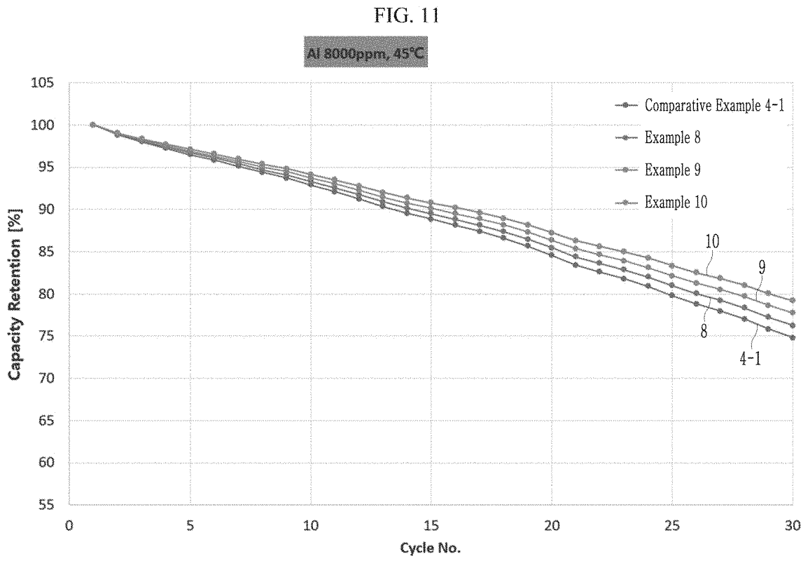

FIG. 11 is a graph i showing the evaluation of high-temperature cycle-life characteristics of the battery cells of Comparative Examples 4-1 and 8 to 10 in which the Al doping amount of the first positive active material is 0.80 wt % and the Zr coating amounts are different from each other. Referring to FIG. 11, Comparative Example 4-1, in which the Zr coating amount was 0.07 wt %, similarly exhibited relatively reduced and insufficient or unsuitable high-temperature cycle-life characteristics, but Examples 8 to 10, in which the Zr coating amount was in a range of 0.10 to 0.15 wt %, exhibited improved high-temperature cycle-life characteristics.

When comparing FIGS. 9 to 11, as the Al doping amount of the first positive active materials increased from 0.5 wt % to 0.8 wt %, the high-temperature cycle-life characteristics were further improved.

### EVALUATION EXAMPLE 8: EVALUATION OF ELECTROCHEMICAL CHARACTERISTICS (DQ/DV) OF Battery Cell

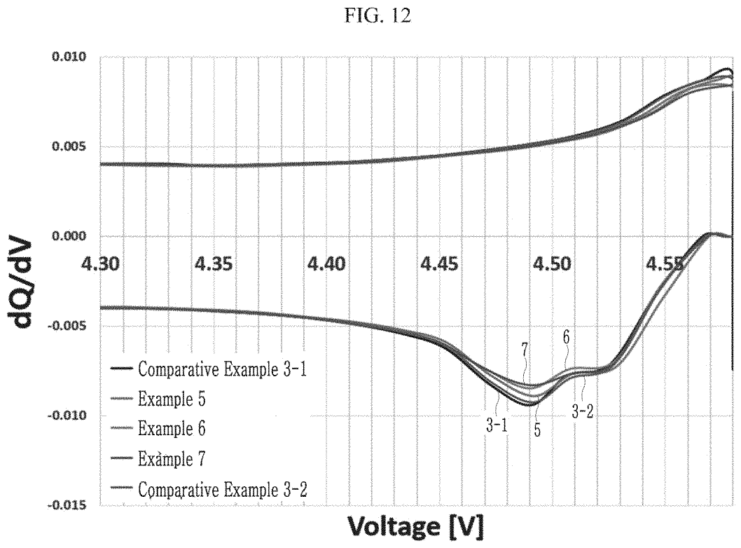

The battery cells of the Examples and the Comparative Examples were charged up to an upper limit voltage of 4.58 V at a constant current of 0.2 C and discharged to a cut-off voltage of 3.0 V at 0.2 C at 25° C. to perform initial charge and discharge, wherein dQ/dV was analyzed. FIG. 12 is a graph of dQ/dV analysis for the battery cells of Comparative Examples 43-1, 3-2 and Examples 5 to 7, in which Al doping amount of first positive active material was 0.65 wt %. In FIG. 12, the more the downcurved curve was upwards (the less the dip of the curve), the more stable was the structure of the positive active material. Referring to FIG. 12, compared with Comparative Example 3-1, in which the Zr coating amount was 0.07 wt %, and Comparative Example 3-2, in which the Zr coating amount was 0.16 wt %, Examples 5 to 7, in which the Zr coating amount was within a range of 0.10 to 0.15 wt %, exhibited upward curves. Accordingly, the positive active materials of Examples 5 to 7, in which the Zr coating amount was in a range of 0.10 to 0.15 wt %, were further structurally stable.

While this disclosure has been described in connection with what is presently considered to be embodiments of the present disclosure, it is to be understood that the present disclosure is not limited to the disclosed embodiments. On the contrary, it is intended to cover various modifications and equivalent arrangements included within the spirit and scope of the appended claims and their equivalents.

Description of Symbols

| | |
|---|---|
| 100: rechargeable lithium battery | 112: negative electrode |
| 113: separator | 114: positive electrode |
| 120: battery case | 140: sealing member |

What is claimed is:

1. A positive active material for a rechargeable lithium battery, the positive active material comprising:
a first positive active material comprising a lithium cobalt-based oxide doped with aluminum and coated with zirconium; and
a second positive active material comprising a lithium cobalt-based oxide doped with aluminum and coated with zirconium,
wherein a particle diameter of the second positive active material is smaller than a particle diameter of the first positive active material,
in the first positive active material, a doping amount of aluminum based on a total weight of the lithium cobalt-based oxide is about 0.50 wt % to about 0.80 wt %, in the second positive active material, a doping amount of aluminum based on the total weight of the lithium cobalt-based oxide is about 0.20 wt % to about 0.40 wt %, and
a coating amount of zirconium based on a total weight of the positive active material is about 0.10 wt % to about 0.15 wt %.

2. The positive active material of claim 1, wherein
the lithium cobalt-based oxide of the first positive active material is represented by Chemical Formula 1, and the lithium cobalt-based oxide of the second positive active material is represented by Chemical Formula 2:
Liₐ₁Coₓ₁Al_{y1}M_{z1}O_{2-b1}, Chemical Formula 1
wherein, in Chemical Formula 1, 0.8≤a1≤1.2, 0.9560≤x1≤0.9819, 0.0181≤y1≤0.0290, 0≤z1≤0.015, x1+y1+z1=1, 0≤b1≤0.05, and M¹ is B, Ba, Ca, Ce, Cr, Cu, F, Fe, Mg, Mn, Mo, Nb, P, S, Si, Sr, V, W, Zr, or a combination thereof, and
Liₐ₂Coₓ₂Al_{y2}M²_{z2}O_{2-b2}, Chemical Formula 2
wherein, in Chemical Formula 2, 0.8≤a2≤1.2, 0.9705≤x2≤9927, 0.0073y2≤0.0145, 0≤z2≤0.015, x2+y2+z2=1, 0≤b2≤0.05, and M² is B, Ba, Ca, Ce, Cr, Cu, F, Fe, Mg, Mn, Mo, Nb, P, S, Si, Sr, V, W, Zr, or a combination thereof.

3. The positive active material of claim 1, wherein
a ratio of an Al weight of the first positive active material to a Zr weight of the positive active material is about 3.3 to about 8.0.

4. The positive active material of claim 1, wherein
a ratio of an Al oxidation number of the first positive active material to a Zr oxidation number of the positive active material is about 2.4 to about 6.0.

5. The positive active material of claim 1, wherein
an average particle diameter (D50) of the first positive active material is about 13 μm to about 25 μm.

6. The positive active material of claim 1, wherein
an average particle diameter (D50) of the second positive active material is about 2 μm to about 6 μm.

7. The positive active material of claim 1, wherein
when an average particle diameter of the first positive active material is a and an average particle diameter of the second positive active material is b, a and b satisfies 3b≤a≤4b.

8. The positive active material of claim 1, wherein
the first positive active material is in an amount of about 60 wt % to about 90 wt %, and the second positive active material is in an amount of about 10 wt % to about 40 wt % based on a total amount of the first positive active material and the second positive active material.

9. A positive electrode for a rechargeable lithium battery, the positive electrode comprising:
a current collector; and
a positive active material layer on the current collector,
wherein the positive active material layer comprises the positive active material of claim 1.

10. The positive electrode of claim 9, wherein
the positive electrode has a loading level of about 15 mg/cm² to about 25 mg/cm².

11. The positive electrode of claim 9, wherein
the positive electrode has a mixture density of about 3.8 g/cc to about 4.2 g/cc.

12. A rechargeable lithium battery comprising the positive electrode of claim 9, a negative electrode, and an electrolyte.
